(19) United States
(12) Patent Application Publication
(10) Pub. No.: US 2024/0042495 A1
(43) Pub. Date: Feb. 8, 2024

(54) SMALL PARTS CLEANING APPARATUS AND METHODS OF USE

(71) Applicant: Genentech, Inc., South San Francisco, CA (US)

(72) Inventors: Ramin Aaron LOUYEH, South San Francisco, CA (US); Matthew SKALLET, South San Francisco, CA (US)

(21) Appl. No.: 18/315,450

(22) Filed: May 10, 2023

Related U.S. Application Data
(63) Continuation of application No. PCT/US2021/058931, filed on Nov. 11, 2021.
(60) Provisional application No. 63/113,664, filed on Nov. 13, 2020.

(51) Int. Cl. B08B 3/04; B08B 13/00

(52) U.S. Cl. CPC B08B 3/048; B08B 13/00

(57) ABSTRACT

Provided herein are systems, methods and devices for cleaning small parts that contact biotechnology or pharmaceutical products during manufacture. A parts cleaning device may be provided with a tank, wheels, at least one jet, an input hose and an output hose configured to couple the at least one jet to an automated Clean In Place system (CIP), a bottom outlet, a restriction device and an overflow outlet. The cleaning device may be configured to ensure that liquid can flow into an interior volume of the tank at a greater rate than liquid flowing out of the bottom outlet, thereby causing the liquid level in the interior volume to rise until it reaches the overflow outlet. The cleaning device may not have any automated equipment but instead may rely on automated equipment in the CIP system to operate.

### CROSS REFERENCE TO RELATED APPLICATIONS

This patent application is a continuation of International Application No. PCT/US2021/058931, titled “SMALL PARTS CLEANING APPARATUS AND METHODS OF USE”, filed Nov. 11, 2021, which claims the benefit of U.S. Provisional Patent Application No. 63/113,664, titled “SMALL PARTS CLEANING APPARATUS AND METHODS OF USE”, filed on Nov. 13, 2020, each of which are herein incorporated by reference in its entirety for all purposes.

### INCORPORATION BY REFERENCE

All publications and patent applications mentioned in this specification are incorporated herein by reference in their entirety to the same extent as if each individual publication or patent application was specifically and individually indicated to be incorporated by reference.

### BACKGROUND

One of the challenges faced by biotechnology and pharmaceutical companies is to clean the equipment and components which are used during the processing of their products and which come in contact with the product. There are several devices that are commonly used for cleaning equipment and components in these industries, which are briefly discussed here.

CIP—Clean In Place—This equipment is stationary, typically installed in a utility area adjacent to a manufacturing area and may have several tanks, a chemical delivery system, instrumentation and automation. The CIP system provides cleaning chemicals and purified water to several designated stations in the manufacturing area, where portable and stationary tanks and transfer lines can be cleaned.

COP—Clean Out of Place—This equipment is typically stationed inside a manufacturing area. This equipment is also stationary. It is mainly used to clean small parts and hoses which may come in contact with product. The COP system is equipped with a chemical delivery system, water supply, drainage, instrumentation and automation for its operation. The COP system typically floods the small parts with cleaning chemicals or water during the cleaning process.

Glass Washer—This equipment also is stationary. It uses spraying devices to clean small parts, mainly glassware. Glass washers are equipped with water, chemical delivery, an adequate drain system, instrumentation and automation for their operation.

All the above systems are relatively expensive to install. A typical installation cost is on the order of several million dollars, not including commissioning and qualification activities.

A good portion of cleaning activities in a biotechnology facility involves cleaning small parts such as elbows, tees, valves, funnels which may come in contact with the biotechnology product during processing. Small parts have been traditionally cleaned either manually (which is labor intensive and may expose personnel to dangerous chemicals), or automatically where the small parts are cleaned in one of the large, dedicated machines described above.

What is needed and is not provided by the prior art are improved systems and methods for cleaning small parts in the biotechnology and pharmaceutical industries, while reducing the costs, delays and facility down time associated with prior art systems. The innovations described herein solve these unmet needs and provide additional advantages.

### SUMMARY OF THE DISCLOSURE

According to aspects of the present disclosure, a small parts cleaning device may be provided with a tank, wheels, at least one jet, an input hose, an output hose, a bottom outlet, a restriction device and an overflow outlet. The has an interior volume configured to receive small parts. Wheels may be attached to a bottom portion of the tank and configured to allow an operator to move the tank when small parts are loaded therein. The at least one jet may be located within the tank and configured to spray small parts loaded therein with liquid. The input hose may be configured to couple the at least one jet to an automated Clean In Place system to deliver liquid thereto. The output hose may be configured to couple the tank to the automated Clean In Place system to return liquid from the tank to the Clean In Place system. The bottom outlet may be located on a bottom portion of the tank and fluidically connected with the output hose. In some embodiments, the restriction device is located between the bottom outlet and the output hose. The overflow outlet may be located on an upper portion of the tank and fluidically connected with the output hose. In some embodiments, the input hose, the bottom outlet, the restriction device and the overflow outlet are configured to cooperate to ensure that liquid can flow into the interior volume of the tank at a greater rate than liquid flowing out of the bottom outlet, thereby causing a liquid level in the interior volume to rise until it reaches the overflow outlet.

In some embodiments, the restriction device comprises a transverse cross-sectional area that is smaller than a transverse cross-sectional area of the output hose. The restriction device may include an intermediate section located between an entry section and an exit section. The intermediate section may include a constant transverse cross-sectional area that is smaller than a transverse cross-sectional area of the entry section and smaller than a transverse cross-sectional area of the exit section. In some embodiments, the intermediate section includes an orifice plate, and or has a length of at least 12 inches. In these embodiments, the constant transverse cross-sectional area of the intermediate section may have a nominal diameter of ¾ of an inch. The restriction device may include a transverse cross-sectional area that is configured to not be changed during a wash cycle. In some embodiments, the restriction device and the overflow port cooperate to ensure that all small parts placed into the interior volume are submersed in liquid during a wash cycle.

In some embodiments, the cleaning device is configured to receive a liquid flow rate of at least about 100 liters per minute and no more than about 300 liters per minute from the Clean In Place system. The cleaning device may be configured to receive a liquid flow rate of about 160 liters per minute from the Clean In Place system, and the restriction device may be configured to limit the liquid flow rate out of the bottom outlet to no more than about 100 liters per minute.

In some embodiments, the cleaning device further includes a plurality of removable baskets configured to receive small parts to be washed and configured to be received within the interior volume of the cleaning device.

In some embodiments, the cleaning device does not include any automated equipment but rather relies on automated equipment in the Clean In Place system to operate. In some embodiments, no electronic control signals are transmitted between the cleaning device and the Clean In Place system during a wash cycle.

According to aspects of the present disclosure, a method of cleaning small parts may include placing small parts to be cleaned in an interior volume of a small parts cleaning device and rolling the small parts cleaning device to a Clean In Place station. The method may further include connecting a liquid fill hose and a liquid drain hose from the small parts cleaning device to the Clean In Place station and starting a wash cycle in the small parts cleaning device from controls located on the Clean In Place station.

In some embodiments, the small parts cleaning device is not electronically connected to the Clean In Place station during a wash cycle and the Clean In Place station controls the wash cycle. In some embodiments, an operator does not need to interact with the small parts cleaning device at all between the time it is connected to the Clean In Place station and the end of a wash cycle.

In some embodiments, the placing small parts step comprises removing baskets from the interior volume of the small parts cleaning device, placing the small parts in the baskets and replacing the baskets in the interior volume. In some embodiments, the placing small parts step occurs before the rolling the small parts cleaning device step. The method may further include, after a wash cycle has been completed, disconnecting the small parts cleaning device from the Clean In Place station, rolling the device back to a location where the small parts were placed into the device, and removing the small parts from the device at that location. In some embodiments, the small parts are placed into the device and removed from the device at multiple locations that are separate from the Clean In Place station.

In some embodiments, the small parts cleaning device includes an overflow port that causes liquid to flow out of the interior volume and back to the Clean In Place system only after the liquid reaches a predetermined height within the interior volume. In these embodiments, the device comprises a restriction device that causes the interior volume to fill up to the predetermined height by limiting the liquid flow rate out of a bottom outlet in fluid communication with the interior volume. The restriction device and the overflow port may cooperate to ensure that all small parts placed into the interior volume are submersed in liquid during a wash cycle.

### BRIEF DESCRIPTION OF THE DRAWINGS

The novel features of the disclosure are set forth with particularity in the claims that follow. A better understanding of the features and advantages of the present disclosure will be obtained by reference to the following detailed description that sets forth illustrative embodiments, in which the principles of the disclosure are utilized, and the accompanying drawings of which:

FIG. 1 is a side view schematically showing a first exemplary embodiment of a parts cleaning device constructed according to aspects of the disclosure;

FIG. 2 is a side view schematically showing a second exemplary embodiment of a parts cleaning device constructed according to aspects of the disclosure;

FIG. 3 is a side view schematically showing a third exemplary embodiment of a parts cleaning device constructed according to aspects of the disclosure; and

FIG. 4 is a side view schematically showing a fourth exemplary embodiment of a parts cleaning device constructed according to the aspects of the disclosure.

### DETAILED DESCRIPTION

According to aspects of the present disclosure, cleaning devices disclosed herein are configured to automatically clean small parts used in biotechnology and pharmaceutical processing. In some embodiments, the cleaning devices have no automation or instrumentation by themselves but are designed to work in conjunction with Clean in Place (CIP) systems that have excess capacity. These novel cleaning devices are far less expensive than other automated systems, as they have no automation by themselves, while offering automated cleaning of the small parts. They can be shaped like a box or a wide cylinder in which the small parts are placed. They are then connected to a CIP system for automated cleaning of the small parts. These systems are flexible, portable and very easy to use. In some embodiments, an operator fills the device with small parts, rolls it to a CIP station, connects it to the CIP station, pushes the start button and walks away. When the operator comes back, the small parts inside the cleaning device have been cleaned.

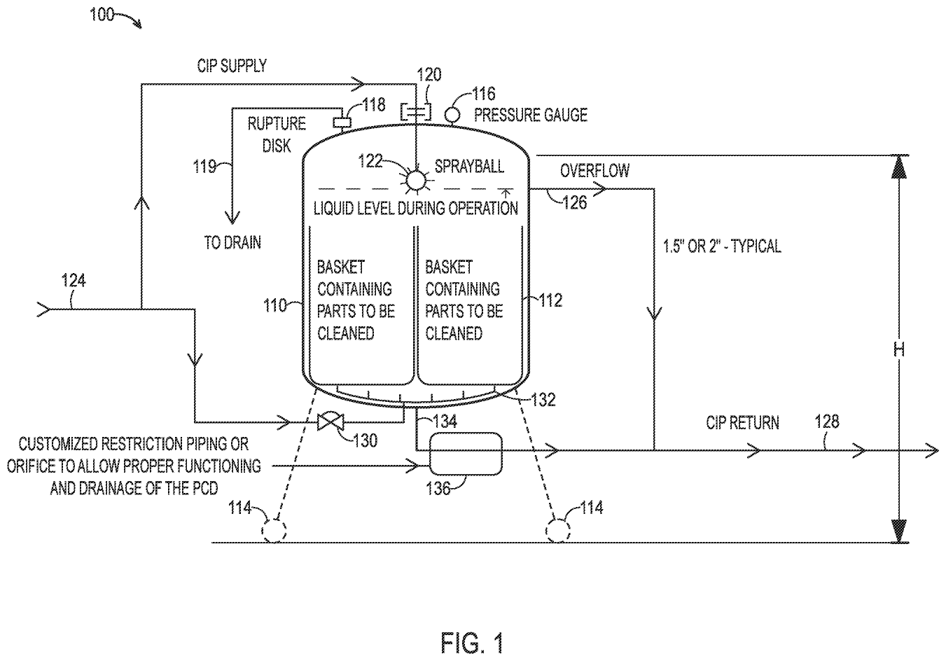

Referring to FIG. 1, a first exemplary embodiment of a parts cleaning device (PCD) 100 constructed according to aspects of the disclosure is provided. In this first embodiment, PCD 100 may be pressurized. As such, the overall shape of the device housing or tank 110 may be cylindrical with domed top and bottom surfaces, as shown. The top may be removable (not shown) to allow small parts to be loaded into one or more baskets 112 and lowered into tank 110. Baskets 112 may be semicircular or wedge shaped to efficiently fill the interior volume of tank 110. The removable top is then replaced and latched down to the cylindrical sidewalls so that tank 110 can be pressurized during a wash cycle. Tank 110 may be provided with rollers 114 so that it may be moved from one location to another. In some implementations, tank 110 is loaded with small parts to be cleaned at a first location, such as near manufacturing equipment where the small parts are used to process a biotechnology product. After tank 110 is loaded with dirty parts, it may then be rolled to a second location, such as a CIP station, where the washing cycle takes place inside tank 110. After the washing cycle has completed, tank 110 may then be rolled back to the first location where the clean parts are removed from tank 110. In some embodiments, the straight section of tank 110 has a maximum height of 44 inches above the floor as shown due to ergonomic considerations. In some embodiments, the bottom of PCD 100 is approximately 16 inches above the floor. In some embodiments, PCD 100 houses two rows of baskets placed on top of each other, each row having four quarter-circle baskets that are 7 inches tall.

In this first exemplary embodiment, the top of tank 110 may be provided with various connections. For example, a pressure indicator 116 may be provided to monitor tank pressure. A rupture disk 118 may be provided and piped to a low point with line 119 to vent tank 110 if it exceeds a predetermined pressure. Two spare ports (not shown) may also be provided. One can be used to supply air to pressurize tank 110 if desired. The other may be used to install an air vent filter. Two sight glasses (not shown) may also be provided. One may be used to shine light through, such as from a flashlight, and the other may be used to view the interior volume of tank 110. Connection 120 may be provided to connect with a sprayball 122 located inside tank 110 for spaying liquid onto the small parts located in baskets 112. In some embodiments, the CIP supply line 124 connected to sprayball 122 should be a 2″ line to accommodate sufficient flow. A valve (not shown) may be provided adjacent to connection 120 for turning off sprayball 122 if desired.

In this first exemplary embodiment, the side of tank 110 may be provided with various connections. For example, an overflow connection 126 may be provided between the top of tank 110 and CIP return line 128, as shown and as will be subsequently described in more detail. In some embodiments, a 1.5″ or 2″ line is used here. A strainer (not shown) may be provided in overflow line 126 to catch any parts that might inadvertently float out of baskets 112.

In this first exemplary embodiment, the bottom of tank 110 may be provided with various connections. For example, a valve 130 may be provided between CIP supply line 124 and jets or outlets 132 on the bottom of tank 110. Flow through jets 132 may be configured to rattle the parts in baskets 112 to facilitate their cleaning. In some embodiments, the line to valve 130 and or jets 132 should be 2″ to accommodate sufficient flow. A drain outlet 134 may be provided between the bottom of tank 110 and CIP return line 128. In some embodiments, drain line 134 includes a restriction device 136 which may include a combination of 1″, ¾″ and in some cases ½″ components and or at least one orifice to restrict the flow rate through drain outlet 134, as will be subsequently described in more detail.

An exemplary method of operation of PCD 100 will now be described. In this method, an operator fills parts to be cleaned in stainless steel baskets 112. Baskets 112 are then placed inside PCD 100. Baskets 112 may be provided with covers, so that the parts being washed do not float away during the wash. In some embodiments, the operator can place up to eight baskets in PCD 100, or a combination of baskets and other parts. After PCD 100 has been loaded with baskets and or other parts, the operator closes the lid to PCD 100. He or she then moves PCD 100 to a CIP cleaning station, if not already located there, and connects PCD 100 to the CIP station with flexible hoses. In particular, the operator connects CIP supply line 124 to a supply port on the CIP (not shown), and connects CIP return line 128 to a return port on the CIP (not shown.) The CIP wash cycle may then be started using the controls on the CIP station to automatically clean all the parts in PCD 100. Note that PCD 100 does not have any automation controls itself, but instead relies on the automation controls of the CIP equipment. In particular, in this first exemplary embodiment, PCD 100 does not include any automation control items such as a pump, automatic valve, timer, switch, electronic sensor or graphical user interface. It is not connected electrically, electronically or wirelessly to the CIP equipment or to any other equipment or source. It does not include any batteries, indicator lights or alarms. Restriction device 136 is advantageous since immersing the parts to be cleaned in cleaning solution and providing a constant flow through tank 110 is desirable for cleaning the parts, but the flow rate of a return pump of a typical CIP system is not variable and is typically too high to allow the tank to flood. Restriction device 136, however, provides automatic filling, draining and constant flow through tank 110 using the standard pumps and controls of existing CIP equipment.

In the first exemplary embodiment, tank 110 of PCD 100 floods up to overflow port 126, so that all the parts being washed are in contact with cleaning solution. The liquid inside PCD 100 also drains during various CIP steps. To accomplish both of these design criteria, the cleaning cycle in PCD 100 begins by introducing cleaning solution through jets 132 on the bottom and or sprayball 122 at the top with a total flow rate of about 160 liters per minute (LPM.) At the same time, a CIP return pump (not shown) attempts to drain the tank through the bottom. However, restriction device 136 is configured to allow only about 100 LPM through CIP return line 128 and to the CIP return pump. Since liquid is being introduced into tank 110 faster than it is being withdrawn, the liquid level in PCD 100 rises and floods the parts being washed until the liquid level reaches overflow port 126. Once the liquid reaches this level, liquid flows into the CIP return pump both through bottom drain port 134 of PCD 100 and through overflow port 126. At this point in the wash cycle, the CIP solution flowing into tank 110 equals the total CIP solution leaving the tank through both bottom drain 134 and overflow port 126, thus establishing a steady level in PCD tank 110. In some embodiments, the tank fill time can be shortened by making restriction device 136 more restrictive, but this also may increase the tank drain time. For any particular implementation, the exact configuration of restriction device 136 can be optimized to provide the shortest CIP wash cycle. This can be accomplished by minimizing the combined fill-up time and drain time for each CIP step.

In this exemplary embodiment, the rate of flow into PCD 100 is about 160% of the rate of flow out of bottom drain 134 and allows tank 110 to fill in about 3 minutes. In other embodiments, the rate of flow into PCD 100 is about 120%, 140%, 180%, 200% or more compared with the rate of flow out of PCD 100. In other embodiments, the relative flow rates may be configured to fill tank 110 in about 1, 2, 4, 5, 6, 7, 8, 9, 10 or more minutes.

At the end of each cleaning step, PCD 100 is drained. The CIP supply pump (not shown) stops, while the CIP return pump runs and drains PCD tank 110, first through both overflow port 126 and bottom drain 134, then after the solution level drops, just through bottom drain 134. In this fashion, PCD 100 goes through all the CIP cleaning steps with a drain step between each cleaning step until the CIP cycle is completed. In some embodiments, ambient air or pressurized air is provided by the CIP equipment to PCD 100 through supply line 124 while tank 110 is being drained. Alternatively, or in combination with this, PCD 100 may be provided with a vacuum break valve (not shown), and or a pressurized air supply (not shown), to allow the liquid being drained from tank 110 to be replaced with an equal volume of air. In some embodiments, the replacement air may be heated and or reduced in humidity to help dry the parts after they have been washed.

When the CIP wash cycle has been completed, which in some embodiments takes about two hours, the operator returns to PCD 100 and checks the pressure gauge on PCD 100 to make sure it is safe to open. The operator then opens PCD 100 and collects the clean/dried components. This can be done either at the CIP station or at another location after PCD 100 has been disconnected from the CIP equipment and rolled to the other location.

Depending on regulatory requirements, PCD 100 itself may need to be cleaned before it is transported to another location where it will be used for cleaning small parts. Sprayball 122 may be used for this purpose. For this operation, a valve (not shown) leading to sprayball 122 may be opened, and jets 132 located at the bottom of tank 110 may be turned off with valve 130. PCD 100 is then connected to a CIP station and is cleaned as with any other portable tank.

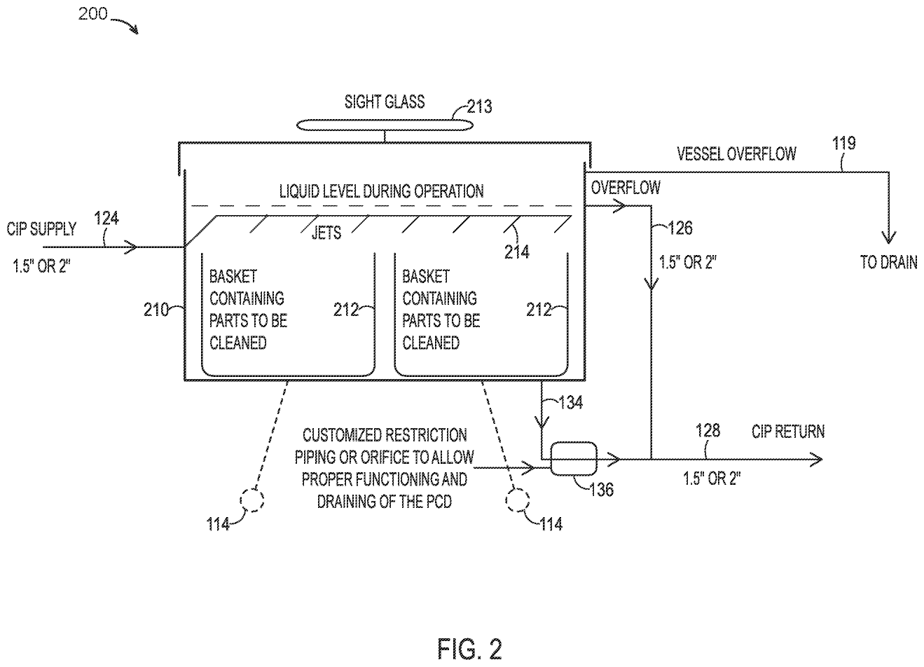

Referring to FIG. 2, a second exemplary embodiment of a parts cleaning device (PCD) 200 constructed according to aspects of the disclosure is provided. In this second embodiment, PCD 200 may be non-pressurized and operate at atmospheric pressure. As such, the overall shape of the device housing or tank 210 may be rectilinear, as shown. At the same time, it may have fewer instruments than the embodiment of FIG. 1. PCD 200 may be constructed and operate in a similar manner as previously described for PCD 100. For example, tank 210 of PCD 200 may be configured to receive one or more removable baskets 212 for holding the small parts to be cleaned. Wheels 114 are located on the bottom of tank 210 to allow PCD 200 to be easily moved. A 12-inch sight glass 213 may be provided on the tank lid for viewing the interior of tank 210 during operation. As previously described with reference to FIG. 1, PCD 200 is also provided with a supply line 124 and a return line 128 for connection to CIP equipment. In this second exemplary embodiment, spray jets 214 are located in the middle of tank 210 and connected to CIP supply line 124 for spraying liquid onto the small parts located in baskets 212. Overflow line 126 connects from near the top of tank 210 to CIP return line 128. Drain line 134 connects from the bottom of tank 210 to CIP return line 128, with restriction device 136 located there between. As depicted in FIG. 2, the liquid level inside tank 210 rises up to the level of overflow connection 126 during operation, similar to the operation of PCD 100 as previously described. This occurs because restriction device 136 is configured to limit the flow rate through bottom drain line 134 over a variety of operating conditions. A secondary overflow line 119 may be provided at a level above overflow line 126 in case CIP return line 128 is unable to keep the liquid level in tank 210 from continuing to rise, such as from a line or filter obstruction, a failed pump or controller, etc.

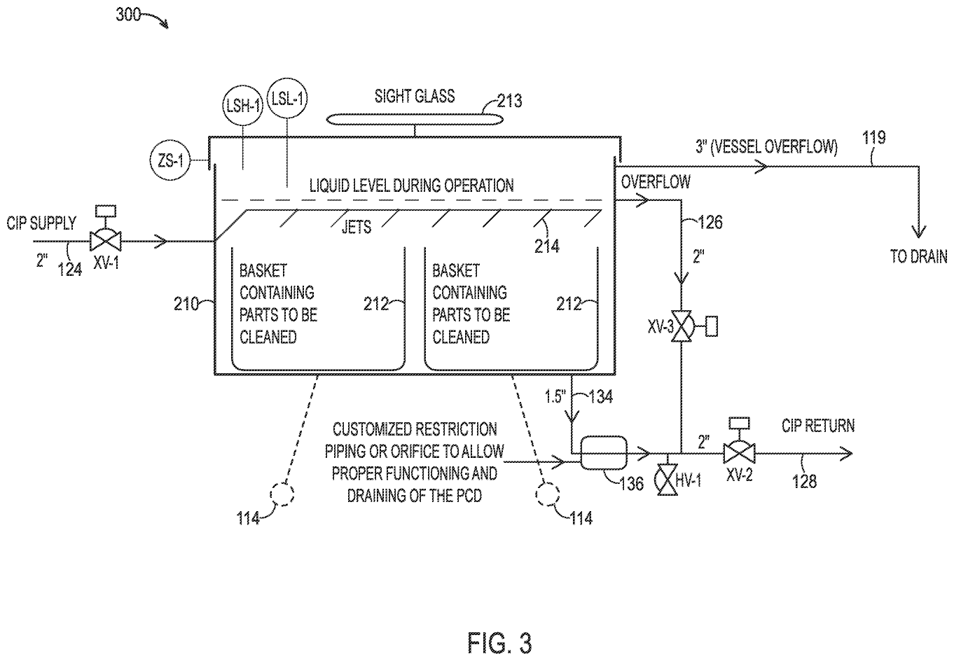

Referring to FIG. 3, a third exemplary embodiment of a parts cleaning device (PCD) 300 constructed according to aspects of the disclosure is provided. PCD 300 may be constructed and operate in a similar or identical manner as previously described for PCD 200. The added instruments and automated valves added to PCD 300 do not have any impact on regular operation of the system. The automated valves and instruments are for added safety only. The automated features in this embodiment include CIP supply and return automated valves XV-1 and XV-2, respectively, overflow automated valve XV-3, PCD drain valve HV-1, lower level switch LSL-1 (to activate automated valve XV-3), high level switch LSH-1 (to prevent overflow from top of the vessel into the room) and proximity switch ZS-1 on the vessel lid (to indicate when the vessel lid is opened.) Operator control buttons (not shown) and a control unit (not shown) may also be provided on PCD 300 to receive input signals from sensors LSL-1, LSH-1 and ZS-1, and to automatically operate valves XV-1, XV-2, XV-3 and HV-1. A control unit may comprise a programmable logic controller (PLC), a series of relays, a processor and/or other control device.

In this exemplary embodiment, when PCD 300 is moved to a CIP station, PCD 300 is connected to an electrical outlet to supply power for operating the automated equipment on PCD 300. PCD 300 may also be connected to a compressed air source for operating the automated valves. In this embodiment, PCD 300 is not electronically connected or wirelessly coupled to a CIP station, and its controller operates independently from the controller of the CIP station.

In this exemplary embodiment, when lower level switch LSL-1 is activated for 15 seconds indicating that a high enough level is reached, automated valve XV-3 is opened. The purpose of this control function is to minimize air introduced in the CIP return line.

High level switch LSH-1 is activated when the liquid level in vessel 210 reaches a very high point, as depicted in FIG. 3. Proximity switch ZS-1 is activated when an individual opens the lid to PCD 300. When either LSH-1 or ZS-1 are activated, both automated valves XV-1 and XV-2 are turned off, stopping CIP supply and return flow, respectively, to PCD 300. This control action causes a shut-down of PCD 300 operation, until the system is reset (valves XV-1 and XV-2 remain closed until PCD 300 is reset.) At this time, the operator should abort the CIP cycle. The operator should then drain the liquid inside PCD 300 via manual valve HV-1, if needed. The operator can then press a start button on PCD 300 to reset the system and start a new CIP cycle. The purpose of this operation is added safety. In the case of tank 210 overflowing to the room, or if an operator opens the lid to the tank 210 during the cleaning operation, valves XV-1 and XV-2 close, shutting down PCD 300 operation until the alarm condition is corrected.

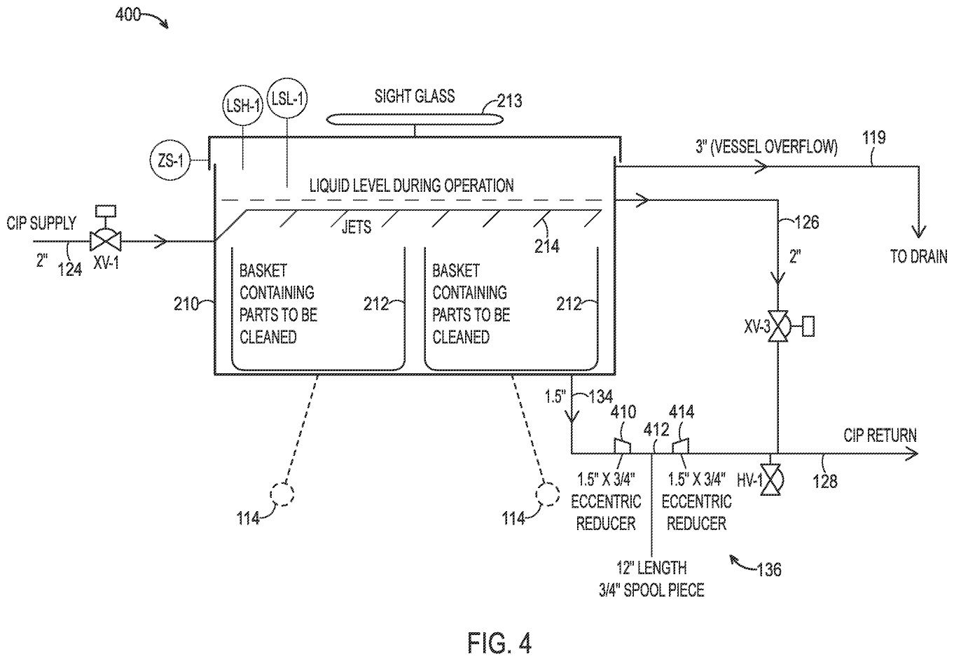

Referring to FIG. 4, a fourth exemplary embodiment of a parts cleaning device (PCD) 400 constructed according to aspects of the disclosure is provided. PCD 400 may be constructed and operate in a similar or identical manner as previously described for PCD 300. In this fourth exemplary embodiment, restriction device 136 is constructed from the following components arranged in series, as shown in FIG. 4. A first eccentric reducer 410 is coupled to tank drain 134 by a 1.5 inch pipe segment. First reducer 410 is followed by a spool piece 412, which in turn is followed by a second eccentric reducer 414. Second reducer 414 is connected to CIP return line 128 through PCD drain valve HV-1. In this exemplary embodiment, first reducer 410 is a 1½″×¾″ eccentric reducer, spool piece 412 is 12″ long and has a diameter of ¾″, and second reducer 414 is a ¾″×1½″ eccentric reducer. In an alternative embodiment, a ¾″ orifice plate (not shown) is placed immediately before or after first reducer 410. Applicants have found that the restriction device 136 arrangements in this fourth embodiment provide the shortest cleaning cycle times on several CIP systems.

In some embodiments, PCD 100, 200, 300 and 400 are constructed to be compatible with CIP systems manufactured by Sani-Matic, Inc. of Sun Prairie, Wisconsin, IPEC of Fort Atkinson, Wisconsin, and/or ESC Engineering of Fort Colins, Colorado.

The parts cleaning systems and methods disclosed herein offer a very inexpensive alternative (less initial capital) for cleaning the small parts which come in contact with product during manufacturing. These devices are considerably less expensive to procure when compared to a stationary cleaning system, such as COP equipment. For example, the cost to build a parts cleaning device as disclosed herein is approximately $100,000, excluding commissioning and validation costs. This is an order of magnitude less than the cost to purchase and install a COP system which is typically about 1.6 million dollars.

These innovative parts clearing devices are also portable, and are therefore flexible and can be taken to various locations for small parts cleaning. Since these devices require minimal to no utility installation before use, production downtime for utility installation can be avoided, such as for installing systems that deliver cleaning chemicals, water supply, drainage, any hoist needed, etc.

While exemplary embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. Numerous different combinations of embodiments described herein are possible, and such combinations are considered part of the present disclosure. In addition, all features discussed in connection with any one embodiment herein can be readily adapted for use in other embodiments herein. It is intended that the following claims define the scope of the invention and that methods and structures within the scope of these claims and their equivalents be covered thereby.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the disclosure. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present disclosure.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and/or methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims. When a feature is described as optional, that does not necessarily mean that other features not described as optional are required.

The examples and illustrations included herein show, by way of illustration and not of limitation, specific embodiments in which the subject matter may be practiced. As mentioned, other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A small parts cleaning device comprising:
a tank having an interior volume configured to receive small parts;
wheels attached to a bottom portion of the tank and configured to allow an operator to move the tank when small parts are loaded therein;
at least one jet located within the tank and configured to spray small parts loaded therein with liquid;
an input hose configured to couple the at least one jet to an automated Clean In Place system to deliver liquid thereto;
an output hose configured to couple the tank to the automated Clean In Place system to return liquid from the tank to the Clean In Place system;
a bottom outlet located on a bottom portion of the tank and fluidically connected with the output hose;
a restriction device located between the bottom outlet and the output hose; and
an overflow outlet located on an upper portion of the tank and fluidically connected with the output hose,
wherein the input hose, the bottom outlet, the restriction device and the overflow outlet are configured to cooperate to ensure that liquid can flow into the interior volume of the tank at a greater rate than liquid flowing out of the bottom outlet, thereby causing a liquid level in the interior volume to rise until it reaches the overflow outlet.

2. The cleaning device of claim 1, wherein the restriction device comprises a transverse cross-sectional area that is smaller than a transverse cross-sectional area of the output hose.

3. The cleaning device of claim 1, wherein the restriction device comprises an intermediate section located between an entry section and an exit section, the intermediate section comprising a constant transverse cross-sectional area that is smaller than a transverse cross-sectional area of the entry section and smaller than a transverse cross-sectional area of the exit section.

4. The cleaning device of claim 3, wherein the intermediate section comprises an orifice plate.

5. The cleaning device of claim 3, wherein the intermediate section has a length of at least 12 inches.

6. The cleaning device of claim 5, wherein the constant transverse cross-sectional area of the intermediate section has a nominal diameter of ¾ of an inch.

7. The cleaning device of claim 2, wherein the restriction device comprises a transverse cross-sectional area that is configured to not be changed during a wash cycle.

8. The cleaning device of claim 1, wherein the restriction device and the overflow port cooperate to ensure that all small parts placed into the interior volume are submersed in liquid during a wash cycle.

9. The cleaning device of claim 8, wherein the cleaning device is configured to receive a liquid flow rate of at least about 100 liters per minute and no more than about 300 liters per minute from the Clean In Place system.

10. The cleaning device of claim 9, wherein the cleaning device is configured to receive a liquid flow rate of about 160 liters per minute from the Clean In Place system, and the restriction device is configured to limit the liquid flow rate out of the bottom outlet to no more than about 100 liters per minute.

11. The cleaning device of claim 1, wherein the cleaning device further comprises a plurality of removable baskets configured to receive small parts to be washed and configured to be received within the interior volume of the cleaning device.

12. The cleaning device of claim 1, wherein the cleaning device does not include any automated equipment but rather relies on automated equipment in the Clean In Place system to operate.

13. The cleaning device of claim 1, wherein no electronic control signals are transmitted between the cleaning device and the Clean In Place system during a wash cycle.

14. A method of cleaning small parts, the method comprising:
placing small parts to be cleaned in an interior volume of a small parts cleaning device;
rolling the small parts cleaning device to a Clean In Place station;
connecting a liquid fill hose and a liquid drain hose from the small parts cleaning device to the Clean In Place station;
starting a wash cycle in the small parts cleaning device from controls located on the Clean In Place station.

15. The method of claim 14, wherein the small parts cleaning device is not electronically connected to the Clean In Place station during a wash cycle and the Clean In Place station controls the wash cycle.

16. The method of claim 14, wherein an operator does not need to interact with the small parts cleaning device at all between the time it is connected to the Clean In Place station and the end of a wash cycle.

17. The method of claim 14, wherein the placing small parts step comprises removing baskets from the interior volume of the small parts cleaning device, placing the small parts in the baskets and replacing the baskets in the interior volume.

18. The method of claim 14, wherein the placing small parts step occurs before the rolling the small parts cleaning device step.

19. The method of claim 14, further comprising, after a wash cycle has been completed, disconnecting the small parts cleaning device from the Clean In Place station, rolling the device back to a location where the small parts were placed into the device, and removing the small parts from the device at that location.

20. The method of claim 19, wherein the small parts are placed into the device and removed from the device at multiple locations that are separate from the Clean In Place station.

21. The method of claim 14, wherein the small parts cleaning device comprises an overflow port that causes liquid to flow out of the interior volume and back to the Clean In Place system only after the liquid reaches a predetermined height within the interior volume, and wherein the device comprises a restriction device that causes the interior volume to fill up to the predetermined height by limiting the liquid flow rate out of a bottom outlet in fluid communication with the interior volume.

22. The method of claim 21, wherein the restriction device and the overflow port cooperate to ensure that all small parts placed into the interior volume are submersed in liquid during a wash cycle.
